(19) United States
(12) Patent Application Publication
(10) Pub. No.: US 2013/0020318 A1
(43) Pub. Date: Jan. 24, 2013

(54) Active Packaging Technology

(71) Applicant: Gary D. Oliver, Broomfield, CO (US)

(72) Inventor: Gary D. Oliver, Broomfield, CO (US)

(73) Assignee: EXTRUSION DIES INDUSTRIES, LLC, Chippewa Falls, WI (US)

(21) Appl. No.: 13/357,874

(22) Filed: Jan. 25, 2012

Related U.S. Application Data
(60) Provisional application No. 61/440,062, filed on Feb. 7, 2011.

(51) Int. Cl. B65D 81/24; B23P 17/00; B29C 69/00; B32B 7/00

(52) U.S. Cl. 220/62.13; 220/62.11; 29/592; 29/428

(57) ABSTRACT

The invention provides active packaging for food, medicine, or other perishable items. The packaging includes at least one active component to capture moisture and/or gas that may otherwise pass through the packaging wall

### CROSS-REFERENCES

This application claims the benefit of U.S. Provisional Application No. 61/440,062, filed on Feb. 7, 2011, the content of which is hereby incorporated by reference in its entirety.

### FIELD OF THE INVENTION

The present invention relates generally to packaging. More specifically, this invention relates to packaging for food, medicine, and other perishable items.

### BACKGROUND OF THE INVENTION

Shelf life in packaging is often determined by the level of oxidation of perishable items inside a package. The presence of oxygen inside the package can cause anything from rancidity to discoloration to bacterial growth. It is therefore desirable to produce containers that have limited oxygen transmission.

Barrier layers have been used to reduce the transmission of oxygen and other detrimental gases through packaging. In plastic packaging, highly crystalline polymers, such as EVOH, are often used in a multi-layer structure to serve as a barrier to the transmission of oxygen and other detrimental gases. Even high quality barrier layers, however, will allow some transmission of gas and moisture. And, when moisture reaches a crystalline polymer barrier material, that material may become less crystalline (e.g., amorphous). When this occurs, the barrier material may lose its barrier properties (or at least experience a decrease in such properties), at which point the packaging may lose much of its ability to block the transmission of oxygen and other detrimental gases.

It would be desirable to provide packaging that is active insofar as being able to capture gas, moisture, or both. It would be particularly desirable to provide active packaging wherein the active component is incorporated into plural layers of a multi-layer packaging wall. Preferably, the active component would be incorporated into particular layers of the multi-layer wall in an arrangement that optimizes the wall's barrier performance. Ideally, the active component would not adversely impact the layers into which it is incorporated or other layers of the packaging wall. Instead, the packaging wall would preferably include multiple active layers that work synergistically with a plurality of barrier layers in the wall.

### SUMMARY OF THE INVENTION

Certain embodiments of the invention provide a packaging wall containing an active component to capture moisture and/or gas that may otherwise pass through the packaging wall. The packaging wall comprises a multi-layer wall that includes at least six layers. The multi-layer wall includes a desired sequence of at least three layers, and this sequence is found at least twice in the packaging wall. Preferably, the active component is incorporated into the two outermost layers of the desired sequence, such that at least four layers comprising the active component are provided in the multi-layer wall.

In some embodiments, the invention provides a method for producing a packaging wall containing an active component to capture moisture and/or gas that may otherwise pass through the packaging wall. The method involves forming a multi-layer wall that includes at least six layers. The multi-layer wall is formed so as to comprise a desired sequence of at least three layers, and this sequence is found at least twice in the packaging wall. Preferably, the active component is incorporated into the two outermost layers of the desired sequence, such that at least four layers comprising the active component are provided in the multi-layer wall.

### BRIEF DESCRIPTION OF THE DRAWINGS

FIG. 1 is a cross-sectional illustration of a multi-layer packaging wall in accordance with certain embodiments of the present invention.

FIG. 2 is a cross-sectional illustration of another multi-layer packaging wall in accordance with other embodiments of the invention.

FIG. 3 is a broken-away cross-sectional illustration of a packaging wall that is part of a container in which a perishable item is contained in accordance with certain embodiments of the invention.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the given examples have many useful alternatives, which fall within the scope of the invention.

The invention provides a multi-layer wall comprising an active component to capture moisture and/or gas. Many packaging containers must meet demanding barrier performance requirements. One notable example is retortable packaging. In retort, the contents of a container may include liquid, oxygen, moisture entrained oxygen, etc., and the atmosphere outside the container will typically include moisture and atmospheric oxygen. Moisture and oxygen thus may penetrate the packaging wall from both sides (i.e., from inside the container and from outside the container). Conventional barrier layers can reduce the transmission of oxygen and other detrimental gases through packaging walls. However, the performance of existing packaging systems (which commonly include at least one barrier layer) could be improved considerably.

The present invention provides a packaging wall that contains an active component to capture moisture and/or gas that may otherwise pass through the packaging wall. The active component in the packaging wall is particularly advantageous when the wall includes one or more barrier layers (e.g., oxygen barrier layers, such as EVOH). In such embodiments, the active component can protect the barrier layer(s) from environmental impact. As noted above, when moisture reaches a crystalline polymer barrier material, the material may become less crystalline (e.g., amorphous). If this occurs, then the barrier material may lose (or experience a decrease in) its barrier properties, at which point the packaging may lose much of its ability to block the transmission of oxygen and other detrimental gases. Thus, in preferred embodiments of the invention, the active component in the packaging wall prevents, reduces, or delays moisture reaching one or more barrier layers embedded within the wall.

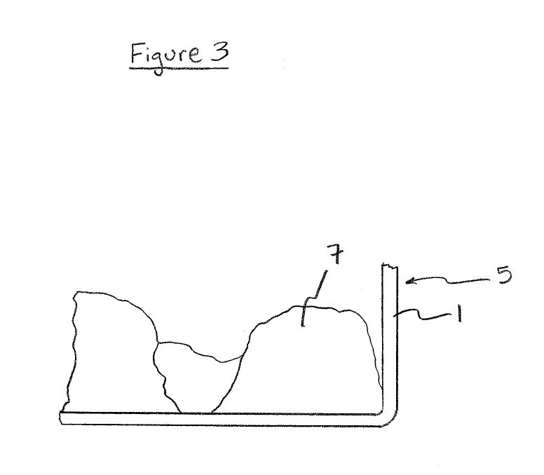

The packaging wall can define, or be part of, a container or another packaging system for perishable items (e.g., oxygen-sensitive products). Examples of perishable items include food, medicine, beverages, and corrodible materials or devices, such as electronic devices. In many cases, the container or other packaging system holds an oxygen-sensitive food or beverage, such as juice, wine, beer, meat, fruit, vegetable, and/or dairy product, to name just a few. In some embodiments, the container or other packaging system defines, or is part of, a substantially air-tight enclosure around the perishable item. Reference is made to FIG. 3.

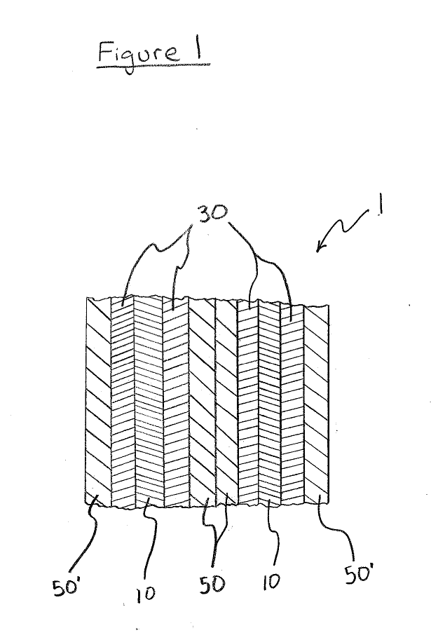

The invention provides a packaging component comprising a multi-layer wall 1. In some embodiments, the multi-layer wall includes at least six layers, or more preferably at least ten layers. In the present embodiments, the multi-layer wall 1 includes a desired sequence (i.e., a “core sequence”) of at least three layers, or more preferably at least five layers, and this sequence occurs at least twice in the packaging wall. Reference is made to the exemplary embodiment of FIG. 1. Here, it can be seen that the multi-layer wall 1 includes one repeat (i.e., two periods) of the following core sequence:

protective boundary layer/tie layer/barrier layer/tie layer/protective boundary layer

Thus, FIG. 1 exemplifies embodiments wherein the core sequence comprises at least five layers. This, of course, is merely one example of a suitable core sequence.

In the present embodiments, the core sequence can be found in the multi-layer wall 1 two times, three times, four times, six times, ten times, etc., depending upon the requirements of the particular application of interest. Thus, the multi-layer wall 1 may be characterized as “2×,” “3×,” “4×,” “5×” . . . “8×,” etc., where the number preceding the “×” refers to the number of periods of the core sequence that exists in the wall.

In the present embodiments, the active component preferably is incorporated into the two outermost layers 50′ of the core sequence. In addition, the active component preferably is contained in a plurality of layers 50 embedded within the wall 1. Thus, the wall 1 of the present embodiments preferably includes at least four layers 50 comprising the active component, as can be appreciated by referring to FIG. 1. Moreover, when the packaging wall includes at least three occurrences (or “periods”) of the core sequence, the multi-layer wall 1 will include at least six layers 50 comprising the active component, when the wall includes at least five periods of the core sequence, there will be at least ten layers 50 comprising the active component, and so on. Thus, by incorporating the active component into the protective boundary layers in particular, and by repeating the core sequence a number of times, the packaging wall can be provided with a formidable number of active layers positioned in a particularly advantageous arrangement.

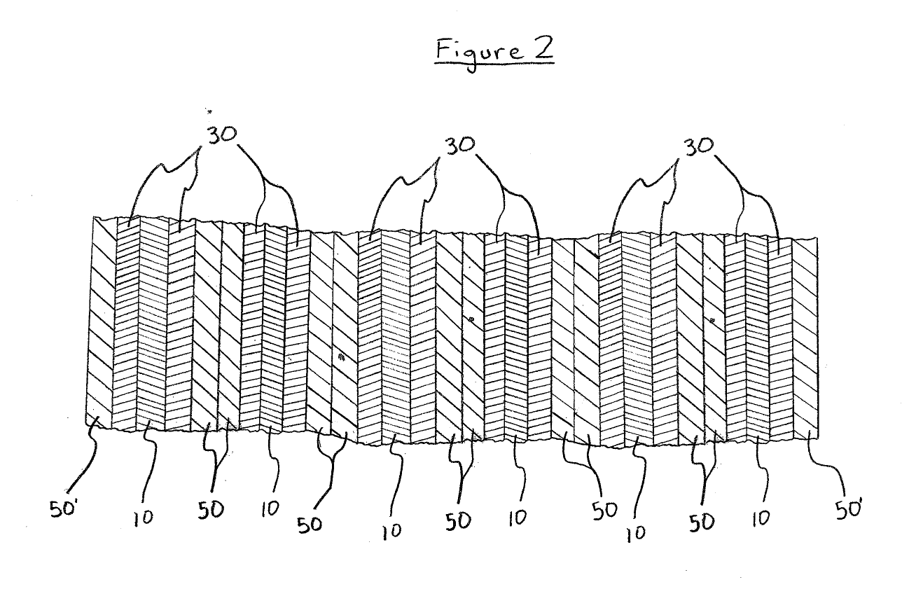

With continued reference to FIG. 1, at least two of the layers 50 comprising the active component are in contact with each other (i.e., are located side-by-side so as to be touching each other) in the illustrated embodiment. Here, the core sequence has been repeated without interposing any layers between the two periods of the core sequence. While this is not strictly required, it will generally be preferred. Thus, in FIG. 1, it can be seen that the two protective boundary layers 50 in the middle of the wall 1 are in contact with each other (i.e., they are contiguous layers). When the packaging wall includes at least three such periods of the core sequence, the multi-layer wall 1 will include at least two sets of contiguous protective boundary layers, when the wall includes at least six periods of the core sequence (see FIG. 2), the wall will include at least five sets of contiguous protective boundary layers, and so on.

In embodiments like those of FIGS. 1 and 2, two of the layers 50 comprising the active component (e.g., two of the protective boundary layers) are exposed outermost layers 50′ of the packaging wall. These two outermost layers 50′ respectively define the surface exposed to the package's interior contents and the surface exposed to the environment outside the package. Embodiments of this nature are particularly advantageous in that both exposed surfaces of the packaging wall 1 contain the active component, and in addition there are multiple active layers 50 embedded inside the wall. In other particularly advantageous embodiments, one or more skin layers (not containing the active component) may be provided over each of the two outermost active layers 50′, such that the skin layers actually define the exposed outermost surfaces of the packaging wall. As just one example, the skin material may be polypropylene.

As can be appreciated from the foregoing discussion, at least two of the layers comprising the active component preferably are embedded layers (i.e., layers having no major surface exposed to either the package's interior contents or the environment outside the package). Moreover, when the packaging wall includes at least three periods of the core sequence, the multi-layer wall 1 preferably includes at least four embedded active layers, when the wall includes at least four periods of the core sequence, there will preferably be at least six embedded active layers, and so on.

The multi-layer wall 1 preferably includes at least one oxygen barrier layer. The embodiments of FIGS. 1 and 2 exemplify preferred embodiments wherein the multi-layer wall 1 includes at least two oxygen barrier layers. For embodiments where the packaging wall includes at least three periods of the core sequence, the multi-layer wall 1 preferably includes at least three oxygen barrier layers, where the wall includes at least eight periods of the core sequence, there preferably will be at least eight barrier layers, and so on. These preferred features, however, are by no means required in all embodiments.

The oxygen barrier layers 10 can comprise any material that serves as an effective barrier to the transmission of oxygen or other detrimental gases through the packaging wall. Polymers and copolymers are preferred. Preferably, the oxygen barrier material has an oxygen permeability of less than 500 cm3 O2/m2·day·atmosphere (tested at 1 mil thick and at 25° C. according to ASTM DS 3985, the salient teachings of which are incorporated herein by reference). Particularly preferred are barrier materials like ethylene vinyl alcohol copolymer (EVOH), polyvinyl alcohol (PVOH), polyamide (PA), polyvinylidene dichloride (PVDC), polyacrylonitrile (PAN), polyethylene napthalate (PEN), metaxylylene adipamide (MXDX), hexamethylene adipamide (nylon 66), and blends. Useful ethylene vinyl alcohol copolymers are commercially available from Kuraray and Nippon Gohsei, both of Japan, as well as EVAL Company of America and Noltex, both of the United States. While polymers will generally be preferred, skilled artisans will appreciate that metal foils and certain other materials may also be used.

When the packaging wall is intended for retort applications, the polymer used should be one that is retortable (e.g., retortable ethylene vinyl alcohol copolymer). Commercially available retortable grades of EVOH include SG372 from Nippon Gohsei and XEP 335 from Kuraray and EVAL Company of America. Thus, in certain embodiments, the multi-layer wall 1 is retortable. Accordingly, certain embodiments provide a retortable container or another retortable packaging system 5. A retortable wall of packaging system remains clear without distortion after conditioning at 121° C. for 30 minutes.

When the multi-layer wall 1 includes one or more oxygen barrier layers, each oxygen barrier layer 10 preferably is separated, by at least one layer 30, from each active layer 50. Reference is made to FIG. 1. Here, each barrier layer 10 is located between, but separated from, two protective boundary layers 50. The layer 30 separating each barrier layer 10 from an adjacent protective boundary layer 50 can be, for example, a tie layer. When provided, the tie layers can provide good adhesion between the barrier layers 10 and the protective boundary layers 50.

Conventional oxygen barrier materials, such as EVOH, tend not to adhere well to other layers. Therefore, it may be desirable to provide adhesive tie layers between the barrier layers 10 and the protective boundary layers 50. Tie layers are well known in the present art. Particularly preferred are tie layers formed of ionomers, vinyl chloride copolymers, polystyrene copolymers, or anhydride-grafted polymers. Examples are maleic-anhydride- or rubber-modified polymers, such as the Plexar series from Quantum Chemical Corp. In particularly preferred embodiments, maleic anhydride grafted olefin tie resins are used.

In certain embodiments, the multi-layer wall 1 includes at least four tie layers 30. This is the case in the embodiments of FIGS. 1 and 2. For embodiments where the packaging wall includes at least three periods of the core sequence, the multi-layer wall 1 preferably includes at least six tie layers, and so on.

Thus, multi-layer wall 1 includes an active component to capture moisture and/or gas. Preferably, the active component (or “active ingredient”) is one that absorbs, reacts with, or otherwise captures moisture, oxygen (and/or another detrimental gas), or both. The presence of the active component prevents or reduces moisture and/or gas penetration, and thus eliminates or reduces degradation of any barrier layers in the packaging wall (thereby preventing, or at least reducing, deterioration of the product inside the packaging).

The active component can be an oxidation catalyst, such as a transition metal catalyst that can readily interconvert between at least two oxidation states. In some embodiments, the active component comprises (or consists essentially of) a transition metal salt or organometal. In some cases, the active component is selected from the group consisting of an iron salt, a nickel salt, a copper salt, a manganese salt, and a cobalt salt.

If desired, the active component can be a functional, oxidizable polydiene, which serves as an oxygen scavenger. Non-limiting examples of functional, oxidizable polydiene as oxygen scavengers include epoxy functionalized polybutadiene (1,4 and/or 1,2), maleic anhydride grafted or copolymerized polybutadiene (1,4 and/or 1,2), epoxy functionalized polyisoprene, and maleic anhydride grafted or copolymerized polyisoprene.

Additionally, or alternatively, the active component can comprise water absorptive agents, such as polyacrylic-type compounds, zeolites, alkaline earth metal oxides, silica, or the like.

In some embodiments, the active component is an iron-based material, such as the ShelfPlus O₂ material, which is commercially available from the Albis Plastic company, which is located in Hamburg, Germany. In some cases, using such an iron-based material may render the resulting product non-recyclable. Therefore, it may be preferred embodiment for certain applications to use the DEHA (N,N Diethylhydroxylamine) scavenging material, which is commercially available from the Chevron Phillips company, which is located in The Woodlands, Tex.

The active component may be incorporated into the protective boundary layers 50 by mixing or blending it with a desired carrier resin during formation of the multi-layer wall. For example, the active component can be provided in the form of particles distributed (e.g., uniformly) throughout the polymer of the protective boundary layer material. Additional details on useful active materials, useful polymer compositions for the protective boundary layers, and useful methods of incorporating the active component into the protective boundary layers can be found in U.S. Pat. Nos. 5,820,956 (Mitsubishi Gas Chemical Company, Inc.) and 6,793,994 (Honeywell International Inc.), as well as U.S. Patent Application No. US2009/0061057 (Cryovac), the salient teachings of each of which are incorporated herein by reference.

Thus, the protective boundary layers 50 comprise one or more active components. As a result, these layers 50 capture moisture and/or oxygen passing through the packaging wall 1. In preferred embodiments, the protective boundary layers 50 capture moisture, so as to prevent barrier layer(s) 10 in the wall from losing their good barrier properties. This can preserve the barrier properties of the packaging wall, thus providing an improved packaging system.

The protective boundary layers 50 can be based on a polymer or copolymer. The material selected preferably facilitates processing (e.g., does not stick to metal dies during extrusion). Useful resins for the protective boundary layers include PE, PP, Nylon, PC, PET, EEA, and the like. In one group of embodiments, each protective boundary layer 50 comprises a maleated polymer. If desired, an acid copolymer, such as DuPont's Surlyn® product, can be used. Skilled artisans in this technology area will be able to select other suitable polymer materials.

In certain embodiments, the multi-layer wall 1 includes the following layers:

protective boundary layer/tie layer/oxygen barrier layer/tie layer/protective boundary layer/protective boundary layer/tie layer/oxygen barrier layer/tie layer/protective boundary layer

Here, the protective boundary layers each comprise the active component, and the oxygen barrier layers each comprise a crystalline polymer or another oxygen barrier material.

The core sequence of layers can be formed by any suitable process. Coextrusion is preferred, and any known coextrusion methods can be used, including blown film or flat die techniques. Many useful techniques for producing multi-layer polymer structures are known to those skilled in the present technology area.

The core sequence of layers can be multiplied, so as to have the desired number of periods, using any suitable layer multiplier technology. Reference is made to U.S. Pat. Nos. 3,239,197 (Tollar) and 5,094,793 (Schrenk et al.), the teachings of each of which are incorporated herein by reference.

FIG. 3 depicts one exemplary embodiment wherein the packaging wall 1 defines, or is part of, a container or packaging system 5 in which a perishable item 7 is contained. The container or packaging system 5 can be a dish, tray, plate, pouch, bag, sleeve, cup, carton, or the like. In some embodiments, the container 5 is a retort tray or another retortable container. Thus, the perishable item 7 can be one intended to be cooked or otherwise heated while inside the container. The item 7 can be food, medicine, a beverage, or another perishable (e.g., oxygen-sensitive) item.

One particular non-limiting example, which is expected to be particularly advantageous, will now be described. The multi-layer wall would comprise a coextrusion composite consisting of (by volume values): 10% copolymer polypropylene/3% tie materials/5% Ethylene Vinyl Alcohol/3% tie material/10% copolymer polypropylene. The initial total thickness of the composite would be maintained throughout the multiplication process. The composite would be divided vertically into segments, spread to a width equal to the original composite width, thinned to half the original thickness and stacked upon each other. The process would be repeated as often as necessary to achieve the desired properties of the composite. The 10% copolymer polypropylene layers act as the protective boundary layers and contain 5% by volume ShelfPlus O2 oxygen scavenger. After the composite has been produced with the desired number of repeats of the initial structure, a final layer or multiple layers would be added to the multiplied composite. In the event the final outer layers are not completely compatible with the composite, a tie layer may be added to the multiplied composite to insure adhesion of the outer layers to the multiplied composite. The overall thickness of the total structure could range from 0.005″ to 0.125″ or greater. The outer layers or structural layer would generally comprise from 5% to 35% each of the total thickness.

One preferred method for creating the initial composite is by using a coextrusion feedblock. Those skilled in the present art would be fully able to perform such coextrusion, particularly given the present teaching as a guide. As already explained, the composite is divided vertically (could be divided into two segments, four segments, or however many is desired), spread, thinned, and stacked. Down stream of the multiplier, another feedblock or multi-cavity die can add final outer layers (using another feedblock may be preferable). The final combination of layers is fed into an extrusion die for shaping the final product. The shaping process involves spreading and thinning the composite, for example, from 1″ to 6″ in width by 0.375″ to 1″, to a finished product from 6″ in width to 120 inches in width by the above thicknesses of 0.005″ to 0.125″ or greater. These details are merely exemplary; they are by no means limiting.

While a preferred embodiment of the present invention has been described, it should be understood that various changes, adaptations and modifications may be made therein without departing from the spirit of the invention and the scope of the appended claims.

What is claimed is:

1. A packaging wall containing an active component to capture moisture and/or gas that may otherwise pass through the packaging wall, the packaging wall comprising a multi-layer wall that includes at least six layers, the multi-layer wall including a desired sequence of at least three layers, the desired sequence being found at least twice in the packaging wall, the active component being incorporated into the two outermost layers of the desired sequence, such that at least four layers comprising the active component are provided in the multi-layer wall.

2. The packaging wall of claim 1 wherein at least two of the layers comprising the active component are in direct contact with each other.

3. The packaging wall of claim 1 wherein two of the layers comprising the active component define exposed outermost layers of the packaging wall.

4. The packaging wall of claim 3 wherein at least two of the layers comprising the active component are embedded layers of the packaging wall.

5. The packaging wall of claim 1 wherein the desired sequence comprises at least five layers.

6. The packaging wall of claim 1 wherein the multi-layer wall includes at least two oxygen barrier layers.

7. The packaging wall of claim 6 wherein each oxygen barrier layer is separated, by at least one layer, from each layer comprising the active component.

8. The packaging wall of claim 6 wherein the oxygen barrier layers each comprise EVOH.

9. The packaging wall of claim 6 wherein the multi-layer wall includes at least four tie layers.

10. The packaging wall of claim 1 wherein the active component comprises a transition metal salt selected from the group consisting of an iron salt, a nickel salt, a copper salt, a manganese salt, and a cobalt salt.

11. The packaging wall of claim 1 wherein the multi-layer wall includes the following layers: protective boundary layer/tie layer/oxygen barrier layer/tie layer/protective boundary layer/protective boundary layer/tie layer/oxygen barrier layer/tie layer/protective boundary layer, wherein the protective boundary layers each comprise the active component, and the oxygen barrier layers each comprise a crystalline polymer.

12. The packaging wall of claim 1 wherein the packaging wall is part of a container in which an oxygen sensitive food item is contained.

13. A method for producing a packaging wall containing an active component to capture moisture and/or gas that may otherwise pass through the packaging wall, the method comprising forming a multi-layer wall that includes at least six layers, the multi-layer wall being formed so as to comprise a desired sequence of at least three layers, the desired sequence being found at least twice in the packaging wall, the active component being incorporated into the two outermost layers of the desired sequence, such that at least four layers comprising the active component are provided in the multi-layer wall.

14. The method of claim 13 wherein the multi-layer wall is formed such that two of the layers comprising the active component define exposed outermost layers of the packaging wall.

15. The method of claim 14 wherein the multi-layer wall is formed such that at least two of the layers comprising the active component are embedded layers of the packaging wall.

16. The method of claim 13 wherein the multi-layer wall is formed such that at least two of the layers comprising the active component are in direct contact with each other.

17. The method of claim 13 wherein the multi-layer wall is formed such that the desired sequence comprises at least five layers.

18. The method of claim 13 wherein the multi-layer wall is formed so as to include at least two oxygen barrier layers.

19. The method of claim 18 wherein the multi-layer wall is formed such that each oxygen barrier layer is separated, by at least one layer, from each layer comprising the active component.

20. The method of claim 13 wherein the multi-layer wall is formed so as to include at least four tie layers, each tie layer being directly between an oxygen barrier layer and a layer comprising the active component.

21. The method of claim 13 wherein the active component incorporated into the packaging wall comprises a transition metal salt selected from the group consisting of an iron salt, a nickel salt, a copper salt, a manganese salt, and a cobalt salt.

22. The method of claim 13 wherein the multi-layer wall is formed by a process that includes coextruding the desired sequence of layers, wherein a first stream resulting from said coextruding is then divided into at least two substreams, each substream comprising the desired sequence of layers, the substreams thereafter being recombined one on top of another into a second stream that comprises at least two periods of the desired sequence of layers.

23. The method of claim 13 wherein the multi-layer wall is formed so as to include the following layers: protective boundary layer/tie layer/oxygen barrier layer/tie layer/protective boundary layer/protective boundary layer/tie layer/oxygen barrier layer/tie layer/protective boundary layer, wherein the protective boundary layers each comprise the active component, and the oxygen barrier layers each comprise a crystalline polymer.
